(19) United States
(12) Patent Application Publication
(10) Pub. No.: US 2025/0277565 A1
(43) Pub. Date: Sep. 4, 2025

(54) MULTI-STAGE PRESSURE REGULATING METHODS AND IOT SYSTEMS FOR NATURAL GAS TRANSMISSION IN DISTRIBUTED ENERGY PIPELINES

(71) Applicant: CHENGDU JIUGUAN SMART ENERGY TECHNOLOGY CO., LTD., Chengdu (CN)

(72) Inventor: Lin FU, Chengdu (CN)

(73) Assignee: CHENGDU JIUGUAN SMART ENERGY TECHNOLOGY CO., LTD., Chengdu (CN)

(21) Appl. No.: 19/181,306

(22) Filed: Apr. 16, 2025

(30) Foreign Application Priority Data
Jan. 20, 2025 (CN) 202510085489.5

(51) Int. Cl. F17D 5/00; F17D 3/16; G16Y 40/10; G16Y 40/30

(52) U.S. Cl. CPC F17D 5/005; F17D 3/16; G16Y 40/10; G16Y 40/30

(57) ABSTRACT

A multi-stage pressure regulating method and internet of things (IoT) system for natural gas transmission in a distributed energy pipeline are provided. The method includes: determining a base booster parameter of a target booster station; determining a characteristic booster parameter of the target booster station; generating and sending a booster command to control the target booster station to perform a booster operation on natural gas in at least one downstream pipeline branch; in response to the booster command being executed, obtaining transportation status data of natural gas in at least one pipeline branch in a preset area; in response to the transportation status data not satisfying a preset condition, determining a linkage adjustment parameter of the target booster station and an associated booster station; and generating and sending a linkage adjustment command to update the characteristic booster parameter of the target booster station and the associated booster station.

### CROSS-REFERENCE TO RELATED APPLICATION

This application claims priority of Chinese Patent Application No. 202510085489.5, filed on Jan. 20, 2025, the content of which is entirely incorporated herein by reference.

### TECHNICAL FIELD

The present disclosure relates to the field of natural gas transmission, and in particular, to a multi-stage pressure regulating method and Internet of Things (IoT) system for natural gas transmission in a distributed energy pipeline.

### BACKGROUND

Manners of transportation of natural gas include pipeline transportation, tanker transportation and ship transportation. Since most of the gas fields are concentrated in deserts, polar tundra, mountains, oceans and other areas, and the distance from the place of origin to the place of use tends to be relatively long, pipeline transportation has become the most common, economical and reasonable way of transporting natural gas in a long distance, in a large scale, and without interruption. When natural gas is transported through a pipeline, the pressure of the natural gas gradually decreases due to the friction between the natural gas and the inner wall of the pipeline, and the influence of valves, elbows, and other devices, which results in a reduction in the efficiency of the pipeline in delivering the gas. Therefore, the problem of decreasing natural gas pressure is usually avoided in long-distance pipeline branches for transporting natural gas by setting up a plurality of booster stations to ensure the smooth transmission of natural gas.

However, the existing booster stations generally use fixed or uniform pressure regulating manners. When the pipeline branches are of different types, located in different environments (different climates, altitudes, differences in height between the two ends of the pipeline, etc.), and have different delivery specifications or requirements, the use of a fixed or uniform manner of pressure regulating may result in the natural gas in the pipeline branches being over-pressurized or under-pressurized, which may lead to the pipeline branches bursting or insufficient natural gas being delivered. Additionally, the existing booster stations usually lack data interaction with other booster stations, resulting in a lack of synergy between a plurality of booster stations, which prevents timely adjustment of the booster parameters of a plurality of booster stations in the face of an emergency situation, thus creating a safety hazard.

Therefore, it is necessary to provide a a multi-stage pressure regulating method and an Internet of Things (IoT) system for natural gas transmission in a distributed energy pipeline, which is capable of individually adjusting the pressure regulating parameters of different booster stations to ensure that the natural gas arrives at its destination safely and efficiently during the long-distance transmission process.

### SUMMARY

One or more embodiments of the present disclosure provide a multi-stage pressure regulating method for natural gas transmission in a distributed energy pipeline. The multi-stage pressure regulating method comprises: obtaining field station information of a target booster station and downstream pipeline data of the target booster station from a database of the management platform, and obtaining booster task information based on distributed in-pipe monitoring devices disposed in at least one upstream pipeline branch in the perception control platform; determining, based on the field station information of the target booster station, a base booster parameter of the target booster station; determining, based on the base booster parameter, the downstream pipeline data, and the booster task information, a characteristic booster parameter of the target boost station; generating a booster command based on the characteristic booster parameter and sending the booster command to the target booster station through the perception control platform to control the target booster station to perform a booster operation on natural gas in at least one downstream pipeline branch; in response to the booster command being executed, obtaining, based on the distributed in-pipe monitoring device, transportation status data of natural gas in at least one pipeline branch in a preset area; in response to the transportation status data not satisfying a preset condition, determining, based on the transportation status data, a linkage adjustment parameter of the target booster station and an associated booster station of the target booster station; and generating a linkage adjustment command based on the linkage adjustment parameter and sending the linkage adjustment command to the perception control platform to update the characteristic booster parameter of the target booster station and a characteristic booster parameter of the associated boost station of the target booster station.

One of the embodiments of the present disclosure provides a multi-stage regulator IoT system for natural gas transmission in a distributed energy pipeline, the system comprising a sequentially interacting operation user platform, an operation service platform, a management platform, a sensing network platform, and a perception control platform. The management platform is configured to: obtain field station information of a target booster station and downstream pipeline data of the target booster station from a database of the management platform, and obtaining booster task information based on distributed in-pipe monitoring devices disposed in at least one upstream pipeline branch in the perception control platform; determine, based on the field station information of the target booster station, a base booster parameter of the target booster station; determine, based on the base booster parameter, the downstream pipeline data, and the booster task information, a characteristic booster parameter of the target booster station; generate a booster command based on the characteristic booster parameter and sending the booster command to the target booster station through the perception control platform to control the target booster station to perform a booster operation on natural gas in at least one downstream pipeline branch; in response to the booster command being executed, obtain, based on the distributed in-pipe monitoring device, transportation status data of natural gas in at least one pipeline branch in a preset area; in response to the transportation status data not satisfying a preset condition, determine, based on the transportation status data, a linkage adjustment parameter of the target booster station and an associated booster station of the target booster station; and generate a linkage adjustment command based on the linkage adjustment parameter and sending the linkage adjustment command to the perception control platform to update the characteristic booster parameter of the target booster station and a characteristic booster parameter of the associated booster station of the target booster station.

One or more embodiments of the present disclosure provide a non-transitory computer-readable storage medium, wherein the storage medium stores a computer command, and when the computer command is executed by a processor, the multi-stage pressure regulating method for natural gas transmission in a distributed energy pipeline is implemented.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a diagram illustrating an exemplary platform architecture of a multi-stage pressure regulating IoT system according to some embodiments of the present disclosure;

FIG. 2 is an exemplary flowchart illustrating a multi-stage pressure regulating method for natural gas transmission in a distributed energy pipeline according to some embodiments of the present disclosure;

FIG. 3 is a schematic diagram illustrating a process for determining a characteristic booster parameter according to some embodiments of the present disclosure;

FIG. 4 is a schematic diagram illustrating a pressure consumption model according to some embodiments of the present disclosure; and

FIG. 5 is a schematic diagram illustrating a process for determining a linkage adjustment parameter according to some embodiments of the present disclosure.

### DETAILED DESCRIPTION

In the following detailed description, numerous specific details are set forth by way of examples in order to provide a thorough understanding of the relevant disclosure. Obviously, drawings described below are only some examples or embodiments of the present disclosure. Those skilled in the art, without further creative efforts, may apply the present disclosure to other similar scenarios according to these drawings. It should be understood that the purposes of these illustrated embodiments are only provided to those skilled in the art to practice the application, and not intended to limit the scope of the present disclosure. Unless obviously obtained from the context or the context illustrates otherwise, the same numeral in the drawings refers to the same structure or operation.

It will be understood that the terms “system,” “engine,” “unit,” “module,” and/or “block” used herein are one method to distinguish different components, elements, parts, sections, or assemblies of different levels in ascending order. However, the terms may be displaced by other expressions if they may achieve the same purpose.

The terminology used herein is for the purposes of describing particular examples and embodiments only and is not intended to be limiting. As used herein, the singular forms “a,” “an,” and “the” may be intended to include the plural forms as well, unless the context clearly indicates otherwise. It will be further understood that the terms “include” and/or “comprise,” when used in this disclosure, specify the presence of integers, devices, behaviors, stated features, steps, elements, operations, and/or components, but do not exclude the presence or addition of one or more other integers, devices, behaviors, features, steps, elements, operations, components, and/or groups thereof.

The flowcharts used in the present disclosure illustrate operations that systems implement according to some embodiments of the present disclosure. It is to be expressly understood, the operations of the flowcharts may be implemented not in order. Conversely, the operations may be implemented in an inverted order, or simultaneously. Moreover, one or more other operations may be added to the flowcharts. One or more operations may be removed from the flowcharts.

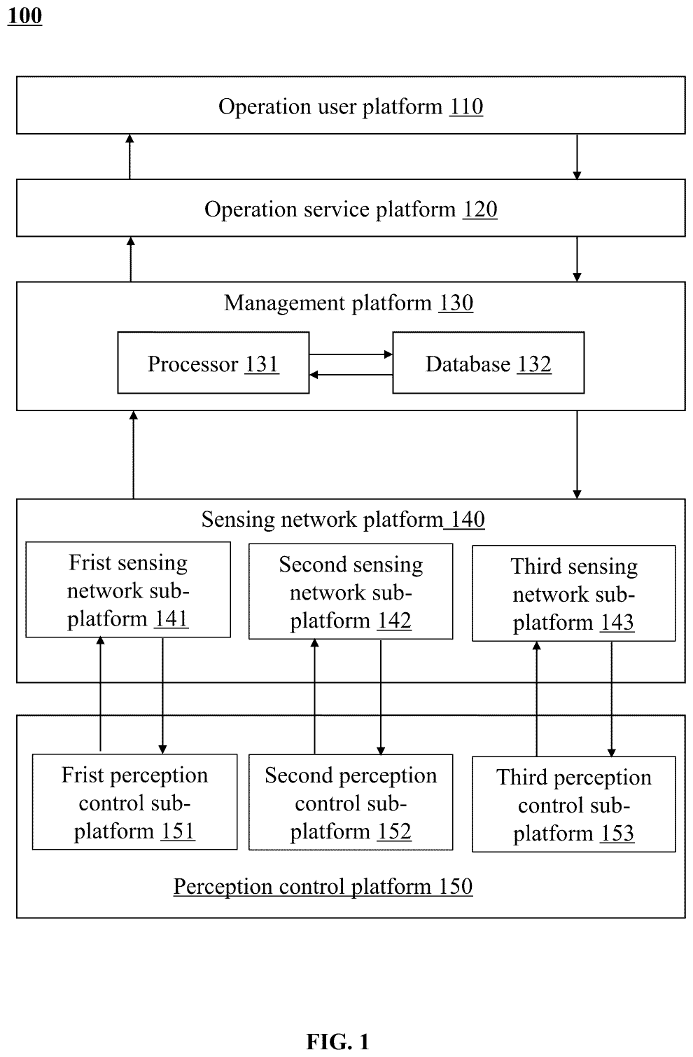

FIG. 1 is a diagram illustrating an exemplary platform architecture of a multi-stage pressure regulating IoT system according to some embodiments of the present disclosure.

As shown in FIG. 1, in some embodiments, the multi-stage pressure regulating IoT system 100 includes an operation user platform 110, an operation service platform 120, a management platform 130, a sensing network platform 140, and a perception control platform 150 that are sequentially interacted.

The operation user platform 110 refers to a platform for interacting with users. In some embodiments, the operation user platform 110 is configured as an end device, i.e., a cellular phone, a computer, and an application, a web page, etc., installed thereon.

In some embodiments, the operation user platform 110 interacts with the operation service platform 120 for information.

The operation service platform 120 refers to a platform for communicating user needs and control information. The operation service platform 120 may obtain information from the management platform 130 (e.g., a database 132) and send the information to the operation user platform 110. For example, the operation service platform 120 sends booster task information, booster parameters, transportation status data within a pipeline branch, pipeline environmental data in which the pipeline branch is located, or the like, to the operation user platform 110. In some embodiments, the operation service platform 120 is configured as a server.

In some embodiments, the operation service platform 120 may interact with the management platform 130 for information.

The management platform 130 refers to a platform that coordinates and harmonizes the connection and collaboration among functional platforms, aggregates all the information of the IoT, and provides perception management and control management functions for the IoT operation system.

In some embodiments, the management platform 130 may include a processor 131 and the database 132. In some embodiments, the processor 131 and the database 132 interact for information. In some embodiments, the processor 131 is configured to process data related to the multi-stage regulator IoT system 100. For example, the processor 131 may determine a base booster parameter for the target booster station based on the field station information for the target booster station. In some embodiments, the database 132 is configured to store data and/or commands related to the multi-stage pressure regulating IoT system 100. For example, the database 132 may store field station information, downstream pipeline data, or the like for a target booster station.

In some embodiments, the management platform 130 may interact with the operation service platform 120 and the sensing network platform 140, respectively, for information. For example, the management platform 130 may send booster parameters to the operation service platform 120. As another example, the management platform 130 may send commands for obtaining current natural gas data and/or historical natural gas data to the sensing network platform 140 to acquire current natural gas data and/or historical natural gas data.

The sensing network platform 140 refers to a functional platform that manages sensing communication. In some embodiments, the sensing network platform 140 refers to a functional platform for sensing communication of perception information and sensing communication of controlling information, e.g., to realize sensing communication of perception information for current natural gas data and/or historical natural gas data. In some embodiments, the sensing network platform 140 may include a first sensing network sub-platform 141 associated with a booster device, a second sensing network sub-platform 142 associated with an in-pipe monitoring device, and a third sensing network sub-platform 143 associated with an environmental perception device. The booster device is a device for increasing the pressure of the natural gas in the pipeline, the in-pipe monitoring device is a device for monitoring the state parameters (e.g., temperature, pressure, etc.) of the natural gas in the pipeline, and the environmental perception device is a device for monitoring the state parameters (e.g., temperature, humidity, etc.) of the environment around the pipeline.

The perception control platform 150 refers to a functional platform for perception information generation and control information execution. In some embodiments, the perception control platform 150 may include a first perception control sub-platform 151 associated with the booster device, a second perception control sub-platform 152 associated with the in-pipe monitoring device, and a third perception control sub-platform 153 associated with the environmental perception device.

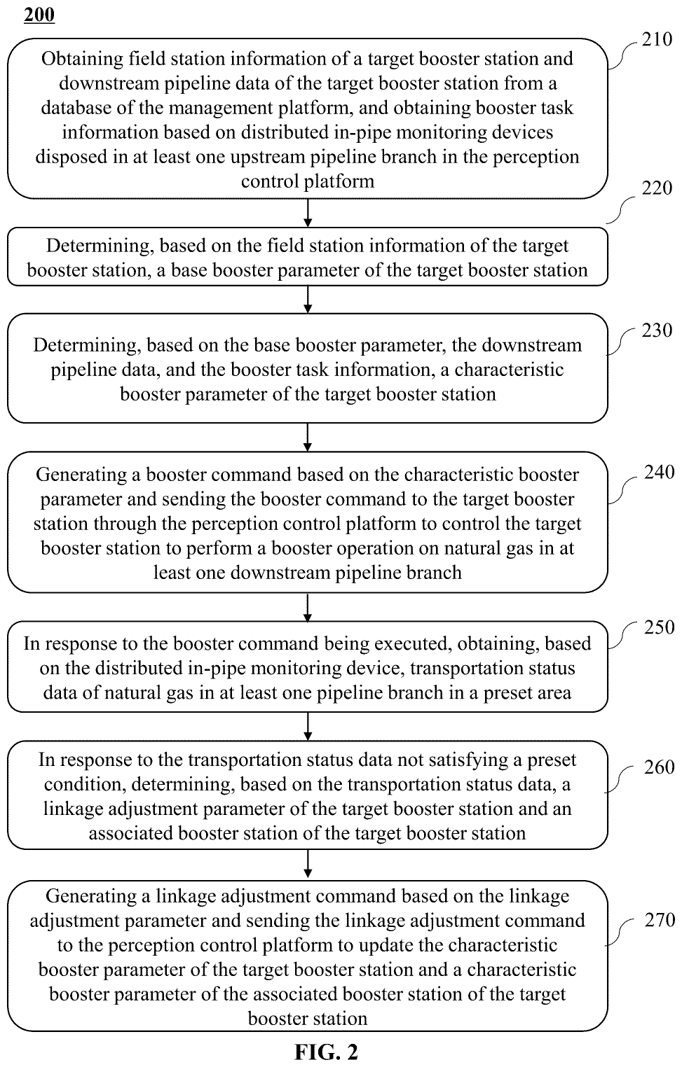

In some embodiments, the perception control platform 150 further includes distributed in-pipe monitoring devices. More descriptions regarding the distributed in-pipe monitoring devices may be found in FIG. 2 and related descriptions thereof.

In some embodiments, each sub-platform in the sensing network platform 140 may be configured as a gateway and a data interface that interacts with each of the sub-platforms in the perception control platform 150. For example, the first sensing network sub-platform 141 may interact with the first perception control sub-platform 151 for information. As another example, the second sensing network sub-platform 142 interacts with the second perception control sub-platform 152 for information. As another example, the third sensing network sub-platform 143 interacts informatively with the third perception control sub-platform 153.

Some embodiments of the present disclosure, based on the multi-stage pressure regulating IoT system 100, can form a closed loop of informational operation between the perception control platform 150 and the operation user platform 110, and under the unified management of the processor 131 of the management platform 130 coordinate and regulate operation, realizing the informatization and intelligence of natural gas delivery to users.

It should be noted that the above description of the multi-stage pressure regulating method and IoT system for natural gas transmission in a distributed energy pipeline is provided only for descriptive convenience, and it does not limit the present disclosure to the scope of the embodiments cited. It is to be understood that for a person skilled in the art, after understanding the principle of the IoT system, it may be possible to arbitrarily combine individual modules or form a sub-system to be connected to other modules without departing from the principle. In some embodiments, the operation user platform 110, the operation service platform 120, the management platform 130, the sensing network platform 140, and the perception control platform 150 disclosed in FIG. 1 may be different platforms in a system, or a single platform may implement the functions of two or more of the above-described platforms. For example, the various platforms may share a common storage module, and the various platforms may each have a respective storage module. Morphs such as these are within the scope of protection of this present disclosure.

FIG. 2 is an exemplary flowchart illustrating a multi-stage pressure regulating method for natural gas transmission in a distributed energy pipeline according to some embodiments of the present disclosure. As shown in FIG. 2, process 200 includes the following operations. In some embodiments of the present disclosure, process 200 may be executed by the management platform 130 (e.g., the processor 131 configured in the management platform 130).

Operation 210, obtaining field station information of a target booster station and downstream pipeline data of the target booster station from a database of the management platform, and obtaining booster task information based on distributed in-pipe monitoring devices disposed in at least one upstream pipeline branch in the perception control platform.

The target booster station refers to a booster station for which the booster parameter need to be determined.

In some embodiments, the management platform may determine a target booster station in a plurality of ways. For example, the management platform may identify a newly operational booster station as a target booster station. As another example, when the amount of change in the natural gas flow rate of the booster station over a preset period of time is greater than a flow rate change threshold and/or the value of change in the natural gas input pressure is greater than an input pressure change threshold, the management platform may identify the booster station as the target booster station. The flow rate change threshold or the input pressure change threshold may be a preset value.

The field station information may reflect attribute characteristics of the target booster station. In some embodiments, the field station information may include a tier of the target booster station, a size of the target booster station, and locations and count of secondary booster stations. A secondary booster station is a downstream booster station that is directly connected to the target booster station via a pipeline branch.

The tier of the booster station may reflect the tier structure of the booster station in the natural gas transmission pipeline network. In some embodiments, the tier of a booster station is represented as level 0, level 1, level 2, level 3, and so on. It will be appreciated that the secondary booster station of the level 2 booster station is a level 3 booster station. The larger tier of the booster station indicates that the booster station is located in the downstream of the natural gas transmission pipeline network, correspondingly, the greater the drop in air pressure during transmission of natural gas inside the pipeline, and the greater the need for booster. The smaller tier of the booster station indicates that the booster station is located in the upstream of the natural gas transmission pipeline network, correspondingly, more downstream booster stations are affected by the booster operation of the booster station.

In some embodiments, the management platform may determine a tier of the booster station in a plurality of ways. For example, a booster station located on a natural gas main pipeline is identified as a level 0 booster station, a booster station that is directly connected to the level 0 booster station through a pipeline branch is identified as a level 1 booster station, and a booster station that is directly connected to the level 1 booster station through a pipeline branch is identified as a level 2 booster station, etc.

The size of the booster station may reflect the booster capacity of the booster station. In some embodiments, the size of the booster station may include a maximum natural gas flow rate of the booster station, a count of booster devices, or the like.

The upstream or downstream of a pipeline branch may reflect the direction in which natural gas flows. The natural gas flows from upstream to downstream. In some embodiments, the natural gas transmission pipeline network may include a plurality of booster stations and a plurality of pipeline branches, wherein the pipeline feeding natural gas to the booster station is an upstream pipeline branch of the booster station, and a pipeline outputting natural gas from the booster station is a downstream pipeline branch of the booster station.

The pipeline data may reflect features associated with pipeline branches. In some embodiments, the pipeline data includes a pipeline size, a spatial location of the pipeline, a pipeline branching condition, or the like. The pipeline size may include a cross-sectional area of the pipeline, and the spatial location of the pipeline may be expressed in the form of a spatial vector, with the starting point and the end point of the spatial vector being the positional coordinates of the pipeline inlet and the pipeline outlet, respectively. The pipeline branching condition may include a count of downstream pipeline branches at an output end of the pipeline branch and a pipeline size for each downstream pipeline branch.

The downstream pipeline data is pipeline data of the downstream pipeline branch.

The downstream pipeline branch includes a collection of at least one pipeline segment between the target booster station to a next level of downstream booster stations. A pipeline segment is a complete section of a natural gas transmission pipeline configured to transport natural gas, and a vast network of natural gas transmission pipelines may be formed by numerous interconnected pipeline segments.

In some embodiments, the count of downstream pipeline branches of the target booster station is the same as the count of secondary booster stations of the target booster station. For example, when the target booster station has N secondary booster stations, the count of downstream pipeline branches of the target booster station is also N.

In some embodiments, the field station information of the booster station and the pipeline data of the pipeline branch may be pre-stored into the database 132, and the processor may directly obtain the field station information of the booster station and the downstream pipeline data of the downstream pipeline branch from the database 132.

The distributed in-pipe monitoring device is a testing device for monitoring correlation parameter of the natural gas in a pipeline branch. The distributed in-pipe monitoring device is set inside the transmission pipeline. In some embodiments of the present disclosure, the distributed in-pipe monitoring device includes a plurality of types of sensors, for example, temperature sensors, pressure sensors, flow sensors, etc. The distributed in-pipe monitoring devices are deployed within pipeline branches.

In some embodiments, a distributed in-pipe monitoring device is configured to obtain booster task information.

The booster task information may reflect correlation parameter of the natural gas to be boosted entering the target booster station. In some embodiments, the booster task information may include a pressure, a flow velocity, and a flow rate of the natural gas to be boosted. The distributed in-pipe monitoring devices include pressure sensors, flow velocity sensors, flow rate sensors, or the like.

In some embodiments, the distributed in-pipe monitoring device may be deployed at key nodes of a pipeline branch for cost savings, for example, a weld of a pipeline branch, a branch of a pipeline branch, or the like.

In some embodiments, the distributed in-pipe monitoring device may also obtain transportation status data. The transportation status data may reflect correlation parameter of boosted natural gas at a downstream pipeline branch of the target booster station. In some embodiments, the transportation status data may include a pressure, a flow velocity, and a flow rate of the boosted natural gas.

Operation 220, determining, based on the field station information of the target booster station, a base booster parameter of the target booster station.

The base booster parameter is a default booster parameter of the booster station. The base booster parameter may reflect the booster parameter for boosting under a normal condition. The normal condition may be a more stable natural gas consumption in the downstream pipeline branch. The normal condition may also be a constant pressure of natural gas in the downstream pipeline branch. In some embodiments, the base booster parameter may include a base natural gas pressure.

In some embodiments, the management platform may determine a base booster parameter for the target booster station in a plurality of ways. For example, the management platform may determine the base booster parameter of the target booster station based on a first preset table. The management platform may construct the first preset table based on the historical field station information and the historical base booster parameters. The first preset table contains correspondences between different historical field station information and different historical base booster parameters. The management platform may determine the current base booster parameter of the target booster station by querying the first preset table based on the current field station information of the target booster station.

Operation 230, determining, based on the base booster parameter, the downstream pipeline data, and the booster task information, a characteristic booster parameter of the target booster station.

The characteristic booster parameter is a booster parameter that is personalized to the specifics of the booster station. In some embodiments, the management platform may increase or decrease the base booster parameter of the target booster station to obtain the characteristic booster parameter of the target booster station.

In some embodiments, the management platform may construct a first feature vector based on the base booster parameters, the downstream pipeline data, and the booster task information of the target booster station; perform a vector matching in a first vector database based on the first feature vector to determine a first association vector; and determine the characteristic booster parameter of the target booster station based on the first association vector.

In some embodiments, there may be a plurality of ways to construct the first feature vector. For example, the first feature vector is constructed by Term Frequency-Inverse Document Frequency (TF-IDF), One-Hot, Word2Vec, etc.

The first vector database may include a plurality of first reference vectors and corresponding reference characteristic booster parameters. Each of the first reference vectors may be constructed based on historical base booster parameters, historical downstream pipeline data, and historical booster task information during a normal operation of the booster station. The first reference vectors are constructed in a similar manner as the first feature vectors. The reference characteristic booster parameter may be an actual characteristic booster parameter corresponding to the first reference vector. The actual booster parameter refers to the historical base booster parameter corresponding to the first reference vector, which remains unchanged after repeated adjustments. “Remains unchanged” means that when the booster task information is constant, the historical booster parameter stays the same.

In some embodiments, the management platform may determine a first reference vector that meets a first preset condition as a first association vector through vector matching. The first preset condition refers to a preset condition for determining the first association vector. In some embodiments, the first preset condition may include that the vector distance satisfies a distance threshold, the vector distance is minimized, or the like.

In some embodiments, the management platform may determine a characteristic booster parameter for a target booster station based on a booster effect of a reference characteristic booster parameter corresponding to the first association vector. For example, the management platform may select the reference characteristic booster parameter with the best booster effect as the final characteristic booster parameter of the target booster station.

The booster effect may reflect how well the characteristic booster parameter is boosted. In some embodiments, the booster effect may include a difference between an actual natural gas pressure at a downstream pipeline branch and an ideal natural gas pressure. The smaller the difference, the closer the actual natural gas pressure at the downstream pipeline branch is to the ideal natural gas pressure, and the better the booster effect. The ideal natural gas pressure may be determined based on a priori experience.

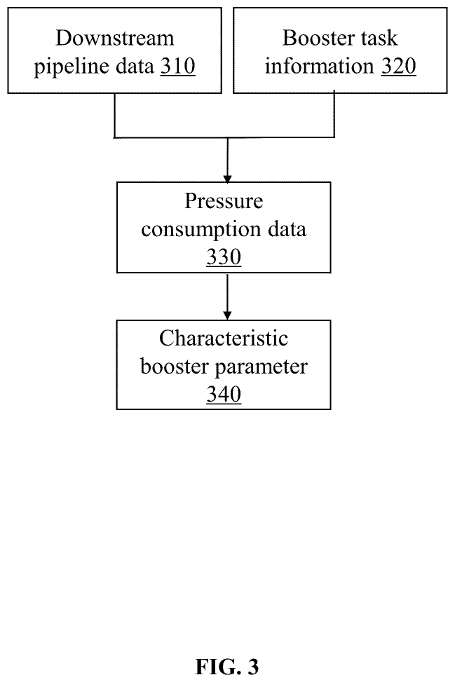

In some embodiments, the management platform may also determine pressure consumption data of the downstream pipeline branch of the target booster station based on the downstream pipeline data and the booster task information; and determine, based on the pressure consumption data of the downstream pipeline branch, the characteristic booster parameter of the target booster station. More descriptions regarding this embodiment may be found in FIG. 3 and related descriptions thereof.

Operation 240, generating a booster command based on the characteristic booster parameter and sending the booster command to the target booster station through the perception control platform to control the target booster station to perform a booster operation on natural gas in at least one downstream pipeline branch.

The booster command is a command configured to regulate an operating state of the booster station. In some embodiments, the booster command includes a magnitude of upward adjustment of the natural gas pressure or a magnitude of downward adjustment of the natural gas pressure of the target booster station.

In some embodiments, the booster command further includes a target natural gas pressure at the target booster station.

In some embodiments, when the target booster station receives a booster command, a booster device (e.g., a natural gas compressor, etc.) within the target booster station may be controlled to boost the natural gas input to the target booster station.

Operation 250, in response to the booster command being executed, obtaining, based on the distributed in-pipe monitoring device, transportation status data of natural gas in at least one pipeline branch in a preset area.

In some embodiments, the management platform obtains the transportation status data of the natural gas in the downstream pipeline branch based on the distributed in-pipe monitoring device configured in the downstream pipeline branch. More descriptions of the distributed in-pipe monitoring device and the transportation status data may be found in above descriptions.

Operation 260, in response to the transportation status data not satisfying a preset condition, determining, based on the transportation status data, a linkage adjustment parameter of the target booster station and an associated booster station of the target booster station.

The preset condition is a judgment condition for determining whether the transportation status data is qualified. In some embodiments, the preset condition may include that the transportation status data includes a natural gas pressure within a preset pressure range, a natural gas flow rate within a preset flow rate range, and a natural gas flow velocity within a preset flow velocity range. The preset pressure range, the preset flow rate range, and the preset flow velocity range may be set based on a priori experience.

In some embodiments, different pipeline branches may correspond to different preset conditions, and the preset conditions of the different pipeline branches may be determined based on the historical transportation status data of the pipeline branch. For example, for a pipeline branch, the management platform may filter the historical transportation status data of the pipeline branch and keep a plurality of sets of historical transportation status data without safety incidents (e.g., natural gas leakage, pipeline breakage, etc.) as reference transportation status data. The management platform may statistically determine a historical pressure range, a historical flow rate range, and a historical flow velocity range for the plurality of sets of reference transportation status data as the preset pressure range, the preset flow rate range, and the preset flow velocity range of the pipeline branch.

In some embodiments, when one of the natural gas pressure, the natural gas flow rate, or the natural gas flow velocity does not lie within the corresponding preset range, the transportation status data is considered to not satisfy the preset condition. In other embodiments of the present disclosure, when any one of the natural gas pressure, the natural gas flow rate, or the natural gas flow velocity does not lie within the corresponding preset range, the transportation status data is considered to not satisfy the preset condition. The preset range includes a preset pressure range, a preset flow rate range, and a preset flow velocity range.

The associated booster station is a booster station whose booster effect is affected by the target booster station. Because pipeline branches often pass through a plurality of booster stations, the characteristic booster parameter of the target booster station often affects the surrounding booster stations.

In some embodiments, the associated booster station of the target booster station may be determined based on a priori experience.

In some embodiments, the management platform may identify parallel booster stations and downstream booster stations corresponding to pipeline branches in the natural gas transmission pipeline network for which the transportation status data satisfies a preset condition but does not satisfy the preset condition when the target booster station adopts the characteristic booster parameter as the associated booster station of the target booster station.

A parallel booster station is a booster station that has the same upstream natural gas station as the target booster station. The upstream natural gas station may include an upstream booster station, an upstream distribution station, an upstream mixing station, or the like. In particular, a gas distribution station is a gas station that regulates the flow rate of natural gas and prevents the return of natural gas, and the gas mixing station is a gas station that regulates the proportion of natural gas components (e.g., mixing natural gas from different sources, adding odorants to natural gas, etc.).

In some embodiments, the management platform may determine, based on the transportation status data of the correlation pipeline branch of the target booster station, status fluctuation data of the correlation pipeline branch; determine, based on the status fluctuation data of the correlation pipeline branch, a correlation influence of the correlation pipeline branch; and determine the associated booster station based on the correlation influence of the correlation pipeline branch.

The status fluctuation data may reflect fluctuations in data within a pipeline segment. For example, the status fluctuation data may reflect fluctuations in data such as natural gas flow velocity, natural gas flow rate, natural gas pressure, or the like, within the pipeline. In some embodiments, for a pipeline branch, the management platform may acquire transportation status data before and after the target booster station adopts the characteristic booster parameter, and determine a difference between the transportation status data acquired before and after as the status fluctuation data of the pipeline branch.

The correlation influence may reflect the extent to which the pipeline branch is influenced by the target booster station. In some embodiments, when the target booster station adopts the characteristic booster parameter, a portion of the booster stations corresponding to the pipeline branches that are less affected by the target booster station do not need to be parameter adjusted. As a result, it is possible to determine whether a booster station corresponding to a pipeline branch is an associated booster station by the correlation influence.

Determining an associated booster station based on the correlation influence of the at least one pipeline branch may be accomplished in a variety of ways. In some embodiments, when the absolute value of the correlation influence of the at least one pipeline branch exceeds a preset correlation threshold, the management platform may identify an upstream booster station of the pipeline branch as an associated booster station. The preset correlation threshold may be preset based on a priori experience.

In some embodiments, the management platform may obtain the status fluctuation data of the historical booster record without safety incidents, and determine a statistical value (e.g., a maximum value, a mean value, a median value, etc.) of the status fluctuation data of the status fluctuation data without safety incidents as a preset correlation threshold.

In some embodiments, determining the associated booster station based on the correlation influence of a pipeline branch can effectively avoid determining a booster station corresponding to a pipeline branch that is less influenced by the target booster station as the associated booster station, thereby avoiding blindly making a large linkage adjustment, which avoids the waste of arithmetic power and time caused by blindly making large-scale linkage adjustments, and helps to improve the response speed and computational efficiency of the IoT system for natural gas transmission in a distributed energy pipeline.

The linkage adjustment parameter is a parameter that synchronizes the adjustment of the booster parameter of the associated booster station and the target booster station. In some embodiments, the linkage adjustment parameter includes a magnitude of adjustment of the natural gas pressure of the associated booster station and the target booster station and a direction of the adjustment, for example, upward by 5% and downward by 10%.

In some embodiments, the management platform may determine a deviation relationship of the transportation status data and determine a linkage adjustment parameter for the target booster station or the associated booster station by querying a linkage adjustment rule.

The deviation relationship may reflect the magnitude by which the transportation status data deviates from the corresponding preset range. The deviation relationship may include a magnitude relationship and a distance of the transportation status data from an upper limit or a lower limit of the corresponding preset range. In some embodiments, when the transportation status data is smaller than the lower limit of the corresponding preset range, the deviation relationship may be expressed as a difference between the distance of the transportation status data and the lower limit of the preset range; when the transportation status data is greater than the upper limit of the corresponding preset range, the deviation relationship may be expressed as the difference between the transportation status data distance and the upper limit of the preset range. For example, when the natural gas pressure is 40 MPa and the preset pressure range is 50 MPa to 100 MPa, the deviation relationship is-10 MPa.

In some embodiments, the linkage adjustment rule includes a mapping relationship between the deviation relationship and the linkage adjustment parameters. For example, the deviation relationship includes adjusting a booster parameter of a corresponding upstream booster station by 10% if the transportation status data is 10% less than a lower limit of a preset range.

In some embodiments, the management platform may determine the linkage adjustment rule based on test results. For example, for a reference deviation relationship, the management platform may continually fine-tune the linkage adjustment parameters adopted by the target booster station or the associated booster station, and monitor whether the transportation status data of the downstream pipeline branch meets the corresponding preset condition. When the preset condition is met, the management platform may take the reference deviation relationship and the corresponding fine-tuned linkage adjustment parameters as a test result. The management platform may determine the linkage adjustment rule based on the test result by function fitting, preset table construction, etc.

In some embodiments, for a target booster station or a downstream pipeline branch of an associated booster station, the management platform may, based on a deviation relationship of the transportation status data of at least one pipeline segment of the downstream pipeline branch, query the linkage adjustment rules by determining a respective linkage adjustment sub-parameter for the at least one pipeline segment. The management platform may determine, based on the linkage adjustment sub-parameters of the at least one pipeline segment, a linkage adjustment parameter of the target booster station and its associated booster station for the downstream pipeline branch by weighted summation. The weight corresponding to the linkage adjustment sub-parameter for each pipeline segment may be positively correlated to a distance from a location on the pipeline segment where the transportation status data is collected to the upstream booster station or the downstream booster station, i.e., the pipeline segments located at both ends have greater weights than pipeline segments located in the middle.

Operation 270, generating a linkage adjustment command based on the linkage adjustment parameter and sending the linkage adjustment command to the perception control platform to update the characteristic booster parameter of the target booster station and a characteristic booster parameter of the associated booster station of the target booster station.

The linkage adjustment command is a command for synchronizing the adjustment of the characteristic booster parameter of the target booster station and the characteristic booster parameter of the associated booster station of the target booster station. In some embodiments, the linkage adjustment command includes a linkage adjustment parameter corresponding to the target booster station and its associated booster station.

In some embodiments, the management platform adjusts the characteristic booster parameter of the target booster station and the characteristic booster parameter of the associated booster station of the target booster station in accordance with the natural gas pressure adjustment magnitude and the direction of the adjustment included in the linkage adjustment parameter, thus updating the characteristic booster parameter of the target booster station and the characteristic booster parameter of the associated booster station of the target booster station.

In some embodiments of the present disclosure, by determining the characteristic booster parameter of the target booster station, it helps to realize individualized adjustment for the booster station so as to ensure that the gas pressure of the downstream pipeline branch of the booster station meets the actual demand; in response to the transportation status data not satisfying preset conditions, the linkage adjustment parameters of the target booster station and its associated booster stations are determined based on the transportation status data, which can take into account the potential impact of changes in the natural gas pressure of the target booster station on the neighboring booster stations while adjusting the booster parameters of the target booster station and making adaptive adjustments, which can help to enhance synergies between different booster stations, thereby enhancing the booster station management capability of the IoT system and the parallel processing capability of regulating a plurality of booster stations simultaneously.

FIG. 3 is a schematic diagram illustrating a process for determining a characteristic booster parameter according to some embodiments of the present disclosure.

In some embodiments, as shown in FIG. 3, the management platform determines, based on downstream pipeline data 310 and booster task information 320, pressure consumption data 330 for a downstream pipeline branch of the target booster station; and determines, based on the pressure consumption data 330, a characteristic booster parameter 340 of the target booster station.

The pressure consumption data is a percentage of pressure drop as natural gas passes through a pipeline branch. The pressure at the outlet of a pipeline is usually less than the pressure at the inlet of the pipeline due to the friction of the natural gas against the walls of the pipeline during transportation and effects of valves and other devices. In some embodiments, the pressure consumption data may be expressed as a percentage decrease in the pressure of the natural gas at the outlet of the downstream pipeline branch compared to the pressure of the natural gas at the inlet of the downstream pipeline branch.

In some embodiments, the management platform may determine the pressure consumption data in a plurality of ways. For example, the management platform may perform a similarity match based on the current downstream pipeline data and booster task information with the historical downstream pipeline data and historical booster task information of the historical pressure regulating records, select a plurality of sets of historical pressure regulating records that satisfy similarity matching conditions, and obtain a plurality of sets of historical pressure consumption data corresponding to the plurality of sets of historical pressure regulating records. The management platform may identify statistical values (e.g., a mean value, a median value, etc.) from the plurality of sets of historical pressure consumption data as pressure consumption data.

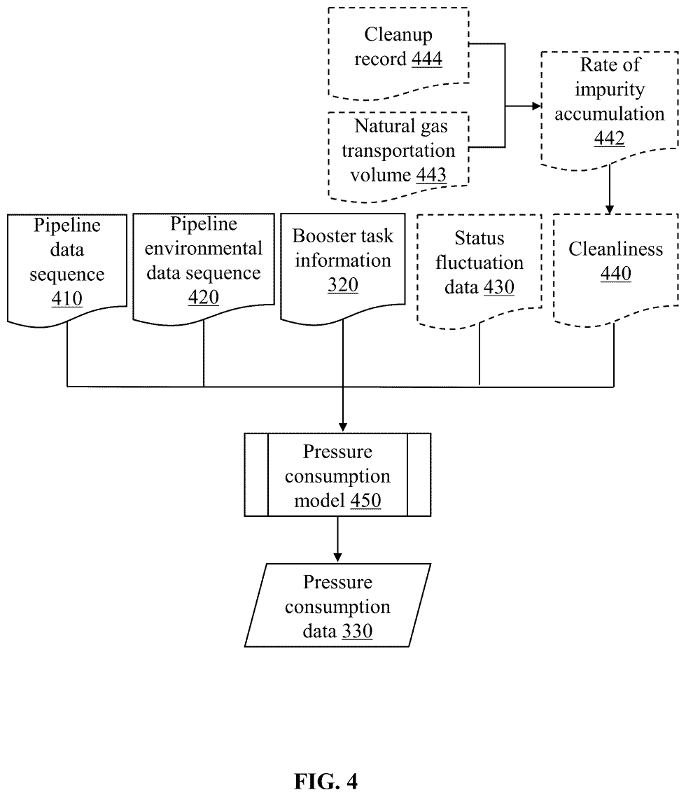

In some embodiments, the management platform may also determine pressure consumption data for a downstream pipeline branch via a pressure consumption model based on booster task information, a pipeline data sequence for the downstream pipeline branch, and a pipeline environmental data sequence. More descriptions regarding this section may be found in FIG. 4 and related descriptions thereof.

In some embodiments, the management platform may acquire pipeline environmental data of at least one pipeline segment in real time based on the environmental perception device; in response to a rate of change of the pipeline environmental data exceeding an environmental change threshold, update, via the pressure consumption model, the pressure consumption data of the downstream pipeline branch, and update a characteristic booster parameter of the target booster station.

The environmental perception device is a device configured to collect pipeline environmental data. The environmental perception device is set outside the transportation pipeline. In some embodiments, the environmental perception device may include, but is not limited to, a temperature sensor, a humidity sensor, a barometric pressure sensor, or the like. The management platform may obtain pipeline environmental data through the environmental perception devices distributed around the pipeline.

The pipeline environmental data is data that reflects attributes characterizing the environment surrounding the pipeline. In some embodiments, the pipeline environmental data includes temperature, humidity, air pressure, or similar factors related to the environment surrounding the pipeline segment.

The rate of change of the pipeline environmental data may reflect the degree of change in the pipeline environmental data. In some embodiments, the rate of change of the pipeline environmental data may be expressed as a magnitude of increase or decrease of the current pipeline environmental data compared to the pipeline environmental data at a preset point in time. The preset point in time may be one hour ago, one day ago, etc., from the current moment.

The environmental change threshold is a judgment threshold configured to determine if the characteristic booster parameter needs to be updated.

In some embodiments, the environmental change threshold may be a system preset value or a human preset value, etc.

In some embodiments, the environmental change threshold for a particular pipeline segment may be positively correlated with the natural gas pressure, the natural gas flow rate, and the natural gas flow velocity of the pipeline segment. For example, when the natural gas pressure, the natural gas flow rate, and the natural gas flow velocity of the pipeline segment are smaller, these parameters are more susceptible to fluctuations in the external environment of the pipeline; in this case, the environmental change threshold may be appropriately lowered, and adjustments may be made in time before fluctuations in the natural gas correlation parameters of the pipeline segment occur.

In some embodiments, the management platform may construct a second feature vector based on the natural gas pressure, natural gas flow rate, and natural gas flow velocity of the current transportation status data; perform vector matching in a second vector database based on the second feature vector to determine a second association vector; and determine a historical environmental change threshold based on the second association vector. The second feature vector is constructed in a manner similar to that of constructing the first feature vector, as described in constructing the first feature vector in FIG. 2.

In some embodiments, the management platform may filter the historical transportation status data, retaining a historical natural gas pressure consistently falling within a preset pressure range, a historical natural gas flow rate consistently falling within a preset flow rate range, and a historical natural gas flow velocity consistently falling within a preset flow velocity range, as candidate transportation status data. For each candidate transportation status data, the management platform may determine the maximum and minimum values of the pipeline environmental data within the preset time period, calculate the rates of change of the maximum and minimum values of the pipeline environmental data relative to the reference environmental data, and select the larger one in the rates of change as the reference environmental change threshold corresponding to the candidate transportation status data. The reference environmental data may be pipeline environmental data corresponding to the historical transportation status data with the natural gas pressure, natural gas flow rate, and natural gas flow velocity being closest to the intermediate values of the preset pressure range, the preset flow rate range, and the preset flow velocity range of the pipeline environmental data, respectively. The reference environmental data may also be preset pipeline environmental data.

The second vector database may include a plurality of second reference vectors and corresponding reference environmental change thresholds. Each of the second reference vectors may be constructed based on the historical natural gas pressure, the historical natural gas flow rate, and the historical natural gas flow velocity of the candidate transportation status data. The second reference vectors are constructed in a similar manner as the second feature vectors. When the second vector database is constructed, it may be stored in a database of the management platform.

In some embodiments, the management platform may determine a second reference vector that meets a second preset condition as a second correlation vector through vector matching, and use a reference environmental change threshold corresponding to the second correlation vector as a final environmental change threshold. The second preset condition refers to a preset condition for determining the second association vector. In some embodiments, the second preset condition may include that the vector distance satisfies a distance threshold, the vector distance is minimized, or the like.

In some embodiments, in response to a rate of change of pipeline environmental data exceeding the environmental change threshold, the management platform may re-determine, based on the sequence of pipeline data and the updated sequence of pipeline environmental data, via the pressure consumption model, the pressure consumption data of the downstream pipeline branch and update the characteristic booster parameter of the target booster station based on the re-determined pipeline environmental data. More descriptions of determining pressure consumption data of the downstream pipeline branch based on the pressure consumption model may be found in later descriptions.

In some embodiments of the present disclosure, by determining the environmental change threshold using the second vector database, the speed and accuracy of determining the environmental change threshold can be effectively improved; in response to the rate of change of pipeline environmental data exceeding the environmental change threshold, the pressure consumption data of the downstream pipeline branch is updated using the pressure consumption model, and the characteristic booster parameter of the target booster station is updated, which can be adjusted in a timely manner when the environment around the pipeline changes significantly, and can help to improve the responsiveness of the IoT system for natural gas delivery in a distributed energy pipeline facing abnormal conditions.

In some embodiments, the management platform may determine the characteristic booster parameter for the target booster station in a plurality of ways based on pressure consumption data for the downstream pipeline branch.

In some embodiments, the management platform may determine an adjustment parameter based on pressure consumption data of a downstream pipeline branch; and determine the characteristic booster parameter for the target booster station based on the adjustment parameter and a base booster parameter for the target booster station. The adjustment parameter includes a percentage of an increase or a decrease. The percentage of increase or decrease may be the same as the percentage of change in the pressure consumption data. For example, the increase in the characteristic booster parameter 340 of the target booster station when the pressure consumption data of the target booster station decreases by 5% may be a 5% increase in the base booster parameter, i.e., 105%*base booster parameter.

In some embodiments, the management platform may also determine a theoretical booster parameter of the downstream pipeline branch based on pressure consumption data of the downstream pipeline branch; and determine the characteristic booster parameter of the target booster station based on the theoretical booster parameter of the downstream pipeline branch.

The theoretical booster parameter is a booster parameter that may satisfy the gas supply demand of the downstream pipeline branch under ideal conditions. The gas supply demand is a minimum natural gas pressure at which natural gas customers connected to the downstream pipeline branch are capable of normally using natural gas. In some embodiments, downstream natural gas customers may not be able to obtain sufficient natural gas when the natural gas pressure within the downstream pipeline branch is too low, and thus the natural gas pressure in the downstream branch needs to be at least sufficient to meet the gas supply demand.

In some embodiments of the present disclosure, the theoretical booster parameter is positively correlated to the ideal natural gas pressure of the downstream pipeline branch and the pressure consumption data of the downstream pipeline branch. More descriptions of the ideal natural gas pressure may be found in FIG. 2 and related descriptions thereof.

Exemplarily, the theoretical booster parameter of the downstream pipeline branch may be obtained based on the following equation (1):

$$L = \frac{Q}{1 - Y} \qquad ( 1 )$$

L denotes a theoretical booster parameter for a downstream pipeline branch, Q denotes an ideal gas pressure of a downstream booster station of the downstream pipeline branch, and Y denotes the pressure consumption data 330 for the downstream pipeline branch.

In some embodiments, there are at least two downstream pipeline branches, and the management platform may determine a theoretical booster parameter for each of the at least two downstream pipeline branches of the target booster station, determine a statistical value (e.g., a mean value, a median value, etc.) of the theoretical booster parameter for each of the at least two downstream pipeline branches as a characteristic booster parameter for the target booster station. Different downstream pipeline branches of the target booster station may be connected to different secondary booster stations.

In some embodiments of the present disclosure, when the pressure consumption data of the downstream pipeline branch is large, the characteristic booster parameter may be appropriately increased so as to ensure that gas supply to the downstream pipeline branch is always sufficient, and when the pressure consumption data of the downstream pipeline branch is small, the characteristic booster parameter may be appropriately decreased, thereby avoiding leakage of the pipeline segment due to excessively high pressure of the natural gas in the downstream pipeline branch, and thereby enhancing the accuracy and applicability of the characteristic booster parameter of the target booster station.

In some embodiments, there are at least two downstream pipeline branches, and the management platform may determine, based on the historical natural gas transportation volume of each of the at least two downstream pipeline branches, a booster weight for each of the at least two downstream pipeline branches; based on the booster weights of the at least two downstream pipeline branches and the theoretical booster parameter, determine the characteristic booster parameter of the target booster station.

The booster weight may reflect the extent to which different downstream pipeline branches are influential in determining the characteristic booster parameter. The sum of the booster weights of the at least two downstream pipeline branches of the target booster station may be 1.

In some embodiments, a booster weight for a downstream pipeline branch may be positively correlated to a historical natural gas transportation volume for the downstream pipeline branch. For example, the greater the historical natural gas transportation volume of the downstream pipeline branch, the more natural gas customers may be affected when an anomaly occurs in the downstream pipeline branch, leading to greater potential losses. As a result, a larger historical natural gas transportation volume of a downstream pipeline branch corresponds to a higher booster weight when determining the characteristic booster parameter of the target booster station.

In some embodiments, the management platform may determine a theoretical booster parameter for each of the at least one downstream pipeline branch of the target booster station, weight and sum the theoretical booster parameters for all of the downstream pipeline branches according to corresponding booster weights. The obtained result is determined as the characteristic booster parameter of the target booster station.

In some embodiments of the present disclosure, determining the characteristic booster parameter of the target booster station based on the respective booster weight and theoretical booster parameter of the at least one downstream pipeline branch can take into account the case where the natural gas flow rate of the downstream pipeline branches is different, more accurately reflect the actual contribution of different downstream pipeline branches to the characteristic booster parameter, and comprehensively take into account the situation when the target booster station has a plurality of downstream pipeline branches, which helps to enhance the scope of applicability of the IoT system for natural gas transmission in a distributed energy pipeline.

FIG. 4 is a schematic diagram illustrating a pressure consumption model according to some embodiments of the present disclosure.

In some embodiments, as shown in FIG. 4, the management platform may obtain a pipeline data sequence 410 of at least one downstream pipeline branch from the database 132 of the management platform; obtain, based on the environmental perception device configured in the perception control platform, a pipeline environmental data sequence 420 of the at least one downstream pipeline branch at a preset time period; and determine the pressure consumption data of the at least one downstream pipeline branch by a pressure consumption model 450 based on the booster task information 320, the pipeline data sequence 410, and the pipeline environmental data sequence 420.

The pipeline data sequence is a sequence obtained by sorting pipeline data of at least one pipeline segment in a downstream pipeline branch. In some embodiments of the present disclosure, the sorting manner may be as follows: sequencing the pipeline segments in the downstream pipeline branch from the target booster station to the downstream booster station. More descriptions regarding the pipeline data may be found in FIG. 2.

The pipeline environmental data sequence is a sequence obtained by sorting pipeline environmental data for at least one pipeline segment in a downstream pipeline branch. The pipeline environmental data sequence may be sorted in the same way as the pipeline data sequence. The pipeline environmental data may reflect characteristics of the environment surrounding the pipeline segment. More descriptions of the pipeline environmental data may be found in FIG. 2.

The preset time period is a time range configured to acquire the pipeline data sequence and the pipeline environmental data sequence. In some embodiments, the preset time period may be preset based on a priori experience, i.e., the past week, the past day, or the like.

The pressure consumption model is a model for predicting pressure consumption data for a downstream pipeline branch. In some embodiments, the linkage booster model may be a machine learning model, for example, any one or a combination of a recurrent neural network (RNN) model and other customized model structures.

In some embodiments, as shown in FIG. 4, inputs to the pressure consumption model 450 may include the pipeline data sequence 410, the pipeline environmental data sequence 420, and the booster task information 320, and outputs may include the pressure consumption data 330 of the downstream pipeline branch.

In some embodiments, the inputs to the pressure consumption model 450 also include the status fluctuation data 430 of the downstream pipeline branch and the cleanliness 440 of the downstream pipeline branch, as shown in FIG. 4.

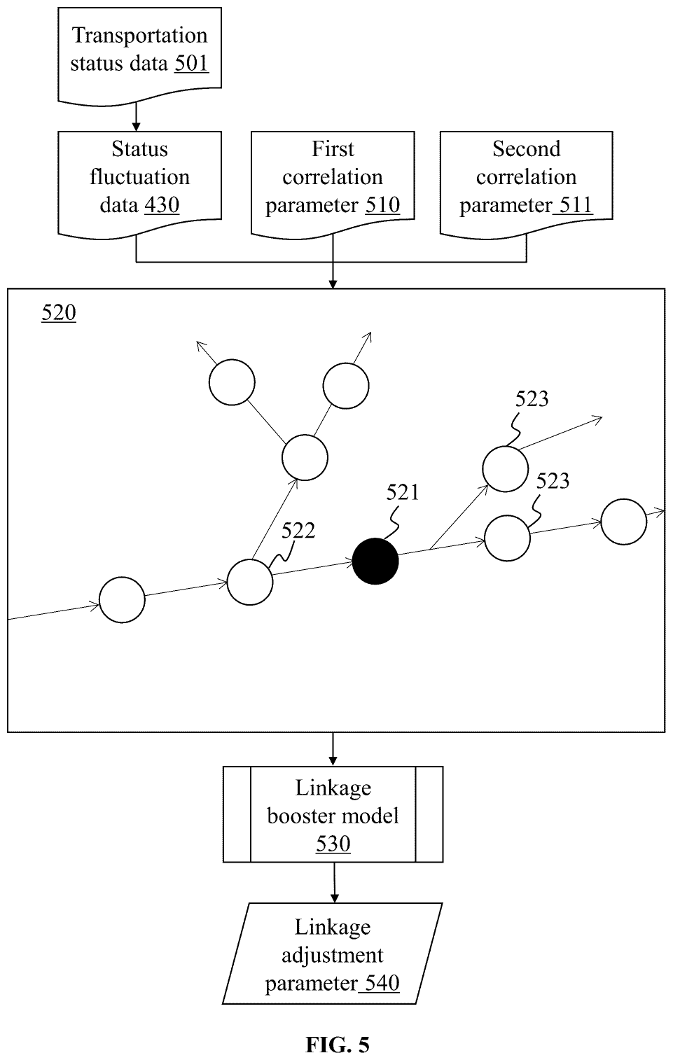

The status fluctuation data may reflect fluctuations in natural gas flow velocity, flow rate, pressure, and other data within a downstream pipeline branch. More descriptions regarding the status fluctuation data may be found in FIG. 5 and related descriptions thereof.

The cleanliness reflects cleanliness of the downstream pipeline branch.

In some embodiments, the management platform may determine the cleanliness of the downstream pipeline branch based on an impurity accumulation within the downstream pipeline branch. For example, the more impurity accumulation, the lower the cleanliness. The correspondence between different impurity accumulations and different cleanliness may be preset based on a priori knowledge or historical data.

The impurity accumulation may reflect how much impurity is cumulatively adhered to the inner wall of a pipeline segment of the downstream pipeline branch. In some embodiments, the impurity accumulation may be expressed as a weight of impurities attached to the inner wall per unit area.

In some embodiments, as shown in FIG. 4, the management platform may: obtain a cleanup record 444 and a natural gas transportation volume 443 of at least one downstream pipeline branch from the database 132 of the management platform; determine, based on the cleanup record 444 and the natural gas transportation volume 443, a rate of impurity accumulation 442 in the downstream pipeline branch; and determine the cleanliness 440 of the downstream pipeline branch based on the rate of impurity accumulation 442 and the natural gas transportation volume between a current moment and a previous cleanup moment of the downstream pipeline branch.

The rate of impurity accumulation is impurity accumulation increased in the downstream pipeline branch as it delivers a unit weight of natural gas. In some embodiments, the management platform may obtain the increased impurity accumulation and the natural gas transportation volume during a preset time period based on the cleanup records and the natural gas transportation volume by the downstream pipeline branch, and further calculate the rate of impurity accumulation during the preset time period. The preset time period is a historical time period, and the breakpoint of the preset time period may be a time point of the cleanup record.

In some embodiments, the management platform may determine the cleanliness of the downstream pipeline branch in a variety of ways based on the rate of impurity accumulation and the natural gas transportation volume between the current moment to the previous cleanup moment of the at least one downstream pipeline branch. For example, the management platform may multiply the natural gas transportation volume in the time period from the current moment to the previous cleanup moment by the rate of impurity accumulation to obtain the impurity accumulation of the downstream pipeline branch at the current moment, which may then determine the cleanliness of the downstream pipeline branch at the current moment.

In some embodiments of the present disclosure, by using the status fluctuation data and the cleanliness of the downstream pipeline branch as inputs to the pressure change model, the data dimensions of the pressure change model are broadened, which can help to improve the generalization ability and prediction accuracy of the model.

In some embodiments, the pressure consumption model may be trained based on a large number of first training samples with a first label. The management platform may perform the following training process to obtain the pressure consumption model. The training process includes: obtaining a plurality of first training samples with a first label to form a first training sample set, and performing a plurality of iterations based on the first training sample set. The at least one round of iteration includes: selecting one or more first training samples from the first training data set, inputting the one or more first training samples into an initial pressure consumption model, obtaining one or more model prediction outputs corresponding to the training samples; substituting the model prediction outputs corresponding to the one or more first training samples and the first labels corresponding to the one or more first training samples into a predefined loss function, calculating a value of the loss function; iteratively updating, based on the value of the loss function, a model parameter in the initial pressure consumption model until an iteration end condition is satisfied, ending the iteration, and obtaining the trained pressure consumption model. The iterative updating of the model parameters of the initial pressure consumption model may be performed by a variety of manners, e.g., the updating may be performed based on the gradient descent manner. The iteration end condition may include the loss function converging or the count of iterations reaching a count threshold, etc.

In some embodiments, the first training sample may include sample booster task information, a sample pipeline data sequence and a sample pipeline environmental data sequence for a sample pipeline branch downstream, and sample booster task information.

In some embodiments, the first label may be sample pressure consumption data corresponding to the first training sample. In some embodiments, the first training sample and the first label may be obtained based on historical data. For example, the management platform may use the historical booster task information, the historical pipeline environmental data sequence, and the historical pipeline data sequence in the historical booster record as a first training sample, and based on the historical pressure at the outlet of the target booster station and the historical pressure at the inlet of the secondary booster station, calculate the historical pressure consumption data as a first label. More descriptions of the secondary booster station may be found in FIG. 2.

In some embodiments, the first training sample may also include sample status fluctuation data and sample cleanliness. For example, the management platform may use the historical status fluctuation data and the historical cleanliness from the historical booster record as the sample status fluctuation data and the sample cleanliness.

In some embodiments of the present disclosure, by using the pressure consumption model to determine the pressure consumption data of the downstream pipeline branch, the data analysis capability and the computational capability of the machine learning model can be effectively utilized to obtain, in a short time, accurate and reliable model prediction results, thereby improving efficiency and saving time, and helping to automate a multi-stage pressure regulating method for natural gas transmission in a distributed energy pipeline.

FIG. 5 is a schematic diagram illustrating a process for determining a linkage adjustment parameter according to some embodiments of the present disclosure.

In some embodiments, as shown in FIG. 5, the management platform may: determine, based on transportation status data 501 of a correlation pipeline branch of the target booster station, the status fluctuation data 430 of the correlation pipeline branch; determine a booster map 520 based on the status fluctuation data 430, a first correlation parameter 510 of the target booster station, and a second correlation parameter 511 of the associated booster station; and determine a linkage adjustment parameter 540 by processing the booster map 520 through a linkage booster model 530.

In some embodiments, the first correlation parameter of the target booster station includes a location of the target booster station, a natural gas flow rate, a characteristic booster parameter, a pipeline data sequence, and a pipeline environmental data sequence.

In some embodiments, the second correlation parameter of the associated booster station includes a location of the associated booster station, a natural gas flow rate, and a characteristic booster parameter.

More descriptions of the associated booster station, transportation status data, status fluctuation data, pipeline data sequence, and pipeline environmental data sequence may be found in FIG. 2.

The booster map is a knowledge graph representing pipeline branches and booster stations. The knowledge graph is a data structure consisting of nodes and edges, edges connecting nodes, and nodes and edges may have attributes. The boosting graph may reflect a relationship between a target booster station and an associated booster station connected by pipeline branches.

The booster map may include at least one node and at least one edge. In some embodiments, the node of the booster map includes a target booster station node and an associated booster station node. The node attributes of the target booster station node and the associated booster station node may include the location coordinates of the booster station, the natural gas flow rate, and the characteristic booster parameter. More descriptions of the natural gas flow rate and characteristic booster parameter may be found in FIG. 2.

In some embodiments, the edge corresponds to a pipeline branch between the nodes, and the attributes of the edge include a pipeline data sequence for the pipeline branch, status fluctuation data, a pipeline environmental data sequence, and a correlation influence.

The distance between two nodes in the booster map may reflect a path distance between two nodes corresponding to booster stations. When there is a pipeline branch connecting the two nodes, the nodes are connected with an edge.

Merely by way of example, as shown in FIG. 5, 521 is a target booster station node corresponding to the target booster station in the booster map, 522 is an upstream booster station of the target booster station node 521, and 523 is a downstream booster station of the target booster station node 521. When the target booster station has two secondary booster stations, two edges are configured to connect to the two secondary booster stations, with the length of each of the edges being positively correlated to the distance of the path from the target booster station to the secondary booster station, the direction of the edges reflecting the directions of flow of natural gas. The associated booster stations correspond to associated booster station nodes in the booster map.

The linkage booster model is a predictive model for predicting linkage adjustment parameters. In some embodiments, the linkage booster model may be a machine learning model, for example, any one or a combination of a graph neural networks (GNN) model or other customized model structures.

In some embodiments, inputs to the linkage booster model 530 may include the booster map 520, and the outputs may include the linkage adjustment parameter 540 corresponding to the different nodes, as shown in FIG. 5.

In some embodiments, the linkage booster model may be obtained by training based on a large number of second training samples with a second label. The management platform may perform the following training process to obtain the linkage booster model. The training process includes: obtaining a plurality of second training samples with a second label to form a second training sample set, and executing a plurality of iterations based on the second training sample set. The at least one round of iteration includes: selecting the one or more second training samples from the second training data set, inputting the one or more second training samples into an initial linkage booster model, obtaining one or more model prediction outputs corresponding to the one or more second training samples; substituting the model prediction outputs corresponding to the one or more second training samples and the second labels corresponding to the one or more second training samples into a formula for a predefined loss function, calculating a value of the loss function; iteratively updating model parameters in the initial linkage booster model according to the value of the loss function until an iteration end condition is satisfied, ending the iteration and obtaining the trained linkage booster model. The iterative updating of the model parameters in the initial linkage booster model may be carried out by a variety of manners, e.g., it may be based on the gradient descent manner. The iteration end condition may include the loss function converging or the count of iterations reaching an iteration count threshold, etc.

In some embodiments, the second training samples may include a sample booster map. The second label may include sample linkage adjustment parameters corresponding to different nodes.

In some embodiments, the second training sample and the second label may be obtained based on historical data. For example, the management platform may obtain, from the database 132 of the management platform, location coordinates, historical natural gas flow rate, historical characteristic booster parameter of a historical target booster station and a historical associated booster station, and historical pipeline data, historical status fluctuation data, historical pipeline environmental data, and historical correlation influence of a historical downstream pipeline branch and a historical correlation pipeline branch, construct a historical booster map as a second training sample, and use historical linkage adjustment parameters of the historical target booster station and the historical associated booster station as a second label.

In some embodiments, after the target booster station and the associated booster station perform the linkage adjustment parameter 540, the original associated booster station may meet the preset conditions since the pipeline data has been changed, which may result in the reduction in the count of the associated booster stations. At the same time, it may also cause more booster stations to be converted to associated booster stations, resulting in a change in the count of associated booster stations.

In some embodiments, in response to an increase in the count of associated booster stations after execution of the linkage adjustment parameter, the management platform may retrieve and obtain target training data in the second training sample set based on an association feature of the target booster station with the associated booster station; and perform scenario-based training on the linkage booster model based on the target training data and the corresponding second label.

The association feature may reflect the extent of the interaction between the target booster station and the associated booster station. In some embodiments, the correlation feature may include a total length of pipeline branches between the target booster station and the associated booster station, a degree of adjacency, and correlation influence of the pipeline branches. The degree of adjacency may reflect a count of booster stations that the target booster station needs to pass through when the target booster station is on the shortest path to the associated booster station, e.g., a degree of adjacency of 1 indicates that one booster station is spaced apart between the target booster station and the associated booster station.

In some embodiments, the management platform may perform a search with the training data in the training data set based on the association feature between the target booster station and the associated booster station, and identify the retrieved training data as the target training data.

For example, the management platform may determine a historical association feature between a historical target booster station and a historical associated booster station in the different training data, and use a current association feature between the target booster station and the associated booster station as an association feature to be matched. The management platform determines training data corresponding to a historical association feature whose similarity satisfies a preset similarity condition as the target training data through similarity matching. The similarity matching algorithm may include, but is not limited to, a Manhattan distance manner, an SVM manner, or the like. The preset similarity condition may be a similarity being greater than a preset similarity threshold, or the like.

In some embodiments, the management platform performs scenario-based training on the linkage booster model 530 based on the target training data to obtain a scenario-based booster model.

Scenario-based training refers to intensive training of the trained linkage booster model 530. In some embodiments, the scenario-based training includes personalized training for the current linked booster station scenario. Scenario-based training is the same as training to obtain a linkage booster model, with the difference being that the scenario-based training is performed with further reinforcement based on the previously trained linkage booster model. For the specific process of performing the scenario-based training of the linkage booster model 530, refer to the foregoing relevant description of the training of the linkage booster model 530.

In some embodiments, when the linkage adjustment parameter 540 is performed, the adjustment may be less effective, increasing the count of booster stations affected by the target booster station, i.e., increasing the count of associated booster stations. The scenario-based booster model obtained by scenario-based training of the linkage booster model 530 helps to improve the applicability and computational accuracy of the linkage booster model 530 for the current scenario, thereby ensuring the prediction effect of the linkage booster model 530.

In some embodiments of the present disclosure, by analyzing and processing the location coordinates of the booster station, the natural gas flow rate, the characteristic booster parameter 340, etc., using the booster map 520, it is possible to effectively discover the potential correlation between different information in the chaotic and complex data.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure, or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures, or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or collocation of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer-readable program code embodied thereon.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

In some embodiments, numbers describing the number of ingredients and attributes are used. It should be understood that such numbers used for the description of the embodiments use the modifier “about”, “approximately”, or “substantially” in some examples. Unless otherwise stated, “about”, “approximately”, or “substantially” indicates that the number is allowed to vary by +20%. Correspondingly, in some embodiments, the numerical parameters used in the description and claims are approximate values, and the approximate values may be changed according to the required characteristics of individual embodiments. In some embodiments, the numerical parameters should consider the prescribed effective digits and adopt the method of general digit retention. Although the numerical ranges and parameters used to confirm the breadth of the range in some embodiments of the present disclosure are approximate values, in specific embodiments, settings of such numerical values are as accurate as possible within a feasible range.

For each patent, patent application, patent application publication, or other materials cited in the present disclosure, such as articles, books, specifications, publications, documents, or the like, the entire contents of which are hereby incorporated into the present disclosure as a reference. The application history documents that are inconsistent or conflict with the content of the present disclosure are excluded, and the documents that restrict the broadest scope of the claims of the present disclosure (currently or later attached to the present disclosure) are also excluded. It should be noted that if there is any inconsistency or conflict between the description, definition, and/or use of terms in the auxiliary materials of the present disclosure and the content of the present disclosure, the description, definition, and/or use of terms in the present disclosure is subject to the present disclosure.

Finally, it should be understood that the embodiments described in the present disclosure are only used to illustrate the principles of the embodiments of the present disclosure. Other variations may also fall within the scope of the present disclosure. Therefore, as an example and not a limitation, alternative configurations of the embodiments of the present disclosure may be regarded as consistent with the teaching of the present disclosure. Accordingly, the embodiments of the present disclosure are not limited to the embodiments introduced and described in the present disclosure explicitly.

What is claimed is:

1. A multi-stage pressure regulating method for natural gas transmission in a distributed energy pipeline, executed based on a management platform of a multi-stage pressure regulating internet of things (IoT) system, the multi-stage pressure regulating IoT system including an operation user platform, an operation service platform, the management platform, a sensing network platform, and a perception control platform, wherein the multi-stage pressure regulating method comprises:
obtaining field station information of a target booster station and downstream pipeline data of the target booster station from a database of the management platform, and obtaining booster task information based on distributed in-pipe monitoring devices disposed in at least one upstream pipeline branch in the perception control platform;
determining, based on the field station information of the target booster station, a base booster parameter of the target booster station;
determining, based on the base booster parameter, the downstream pipeline data, and the booster task information, a characteristic booster parameter of the target booster station;
generating a booster command based on the characteristic booster parameter and sending the booster command to the target booster station through the perception control platform to control the target booster station to perform a booster operation on natural gas in at least one downstream pipeline branch;
in response to the booster command being executed, obtaining, based on the distributed in-pipe monitoring device, transportation status data of natural gas in at least one pipeline branch in a preset area;
in response to the transportation status data not satisfying a preset condition, determining, based on the transportation status data, a linkage adjustment parameter of the target booster station and an associated booster station of the target booster station; and
generating a linkage adjustment command based on the linkage adjustment parameter and sending the linkage adjustment command to the perception control platform to update the characteristic booster parameter of the target booster station and a characteristic booster parameter of the associated booster station of the target booster station.

2. The multi-stage pressure regulating method of claim 1, wherein the determining, based on the base booster parameter, the downstream pipeline data, and the booster task information, a characteristic booster parameter of the target booster station includes:
determining pressure consumption data of the downstream pipeline branch of the target booster station based on the downstream pipeline data and the booster task information; and
determining, based on the pressure consumption data of the downstream pipeline branch, the characteristic booster parameter of the target booster station.

3. The multi-stage pressure regulating method of claim 2, wherein the determining pressure consumption data of the at least one downstream pipeline branch includes:
obtaining a pipeline data sequence of the at least one downstream pipeline branch from the database of the management platform; the at least one downstream pipeline branch including at least one pipeline segment, the pipeline data sequence including pipeline data of the at least one pipeline segment;
obtaining, based on an environmental perception device configured in the perception control platform, a pipeline environmental data sequence of the at least one downstream pipeline branch at a preset time period; the pipeline environmental data sequence including pipeline environmental data of the at least one pipeline segment; and
determining the pressure consumption data of the at least one downstream pipeline branch by a pressure consumption model based on the booster task information, the pipeline data sequence, and the pipeline environmental data sequence, the pressure consumption model being a machine learning model.

4. The multi-stage pressure regulating method of claim 3, wherein an input of the pressure consumption model further includes status fluctuation data of the at least one downstream pipeline branch and a cleanliness of the at least one downstream pipeline branch;
the cleanliness of the downstream pipeline branch is determined in a manner including:
obtaining a cleanup record and a natural gas transportation volume of the at least one downstream pipeline branch from the database of the management platform, and determining, based on the cleanup record and the natural gas transportation volume, a rate of impurity accumulation in the at least one downstream pipeline branch; and
determining the cleanliness of the at least one downstream pipeline branch based on the rate of impurity accumulation and a natural gas transportation volume between a current moment to a previous cleanup moment of the at least one downstream pipeline branch.

5. The multi-stage pressure regulating method of claim 3, further comprising:
obtaining the pipeline environmental data of the at least one pipeline segment based on the environmental perception device in real time; and
in response to a change rate of the pipeline environmental data exceeding an environmental change threshold, updating the pressure consumption data of the at least one downstream pipeline branch by the pressure consumption model and updating the characteristic booster parameter of the target booster station.

6. The multi-stage pressure regulating method of claim 2, wherein the determining, based on the pressure consumption data of the downstream pipeline branch, the characteristic booster parameter of the target booster station includes:
determining, based on the pressure consumption data of the downstream pipeline branch, a theoretical booster parameter of the at least one downstream pipeline branch; and
determining, based on the theoretical booster parameter of the at least one downstream pipeline branch, the characteristic booster parameter of the target booster station.

7. The multi-stage pressure regulating method of claim 6, wherein the at least one downstream pipeline branch includes at least two downstream pipeline branches, and the determining, based on the theoretical booster parameter of the at least one downstream pipeline branch, the characteristic booster parameter of the target booster station includes:
determining, based on a historical natural gas transportation volume of each of the at least two downstream pipeline branches, a booster weight of each of the at least two downstream pipeline branches; and
determining the characteristic booster parameter of the target booster station based on the booster weight and the theoretical booster parameter of each of the at least two downstream pipeline branches.

8. The multi-stage pressure regulating method of claim 1, wherein the associated booster station is determined in a manner including:
determining, based on transportation status data of a correlation pipeline branch of the target booster station, status fluctuation data of the correlation pipeline branch;
determining, based on the status fluctuation data of the correlation pipeline branch, a correlation influence of the correlation pipeline branch; and
determining the associated booster station based on the correlation influence of the correlation pipeline branch.

9. The multi-stage pressure regulating method of claim 1, wherein the determining, based on the transportation status data, a linkage adjustment parameter of the target booster station and an associated booster station of the target booster station includes:
determining, based on transportation status data of a correlation pipeline branch of the target booster station, status fluctuation data of the correlation pipeline branch;
determining a booster map based on the status fluctuation data of the correlation pipeline branch, a first correlation parameter of the target booster station, and a second correlation parameter of the associated booster station, wherein the first correlation parameter includes a location and a natural gas flow of the target booster station, the characteristic booster parameter, a pipeline data sequence, and a pipeline environmental data sequence, wherein the second correlation parameter includes a location and a natural gas flow, and the characteristic booster parameter of the associated booster station; and
determining the linkage adjustment parameter by processing the booster map through a linkage booster model, the linkage booster model being a machine learning model.

10. The multi-stage pressure regulating method of claim 9, wherein the linkage booster model is obtained by training, and the training includes:
obtaining a plurality of training samples with labels to form a training sample set, and executing a plurality of rounds of iterations based on the training sample set, wherein each of the training samples includes a sample booster map, and each of the labels includes sample linkage adjustment parameters corresponding to different nodes in the sample booster map; and at least one of the plurality of rounds of iterations includes:
selecting at least one training sample from the training sample set for input to an initial linkage booster model, obtaining at least one model prediction output corresponding to the at least one training sample;
determining a loss function based on the at least one predicted output corresponding to the at least one training sample and at least one label of the at least one training sample;
iteratively updating model parameters of the initial linkage booster model based on the loss function; and
in response to an end-of-iteration condition being satisfied, ending the iteration to obtain the linkage booster model.

11. A multi-stage pressure regulating internet of things (IoT) system for natural gas transmission in a distributed energy pipeline, wherein the system comprises a sequentially interacting operation user platform, an operation service platform, a management platform, a sensing network platform, and a perception control platform;
the management platform is configured to:
obtain field station information of a target booster station and downstream pipeline data of the target booster station from a database of the management platform, and obtaining booster task information based on distributed in-pipe monitoring devices disposed in at least one upstream pipeline branch in the perception control platform;
determine, based on the field station information of the target booster station, a base booster parameter of the target booster station;
determine, based on the base booster parameter, the downstream pipeline data, and the booster task information, a characteristic booster parameter of the target booster station;
generate a booster command based on the characteristic booster parameter and sending the booster command to the target booster station through the perception control platform to control the target booster station to perform a booster operation on natural gas in at least one downstream pipeline branch;
in response to the booster command being executed, obtain, based on the distributed in-pipe monitoring device, transportation status data of natural gas in at least one pipeline branch in a preset area;
in response to the transportation status data not satisfying a preset condition, determine, based on the transportation status data, a linkage adjustment parameter of the target booster station and an associated booster station of the target booster station; and
generate a linkage adjustment command based on the linkage adjustment parameter and sending the linkage adjustment command to the perception control platform to update the characteristic booster parameter of the target booster station and a characteristic booster parameter of the associated booster station of the target booster station.

12. The multi-stage pressure regulating internet of things (IoT) system of claim 11, wherein the management platform is further configured to:
determine pressure consumption data of the downstream pipeline branch of the target booster station based on the downstream pipeline data and the booster task information; and
determine, based on the pressure consumption data of the downstream pipeline branch, the characteristic booster parameter of the target booster station.

13. The multi-stage pressure regulating internet of things (IoT) system of claim 12, wherein the management platform is further configured to:
obtain a pipeline data sequence of the at least one downstream pipeline branch from the database of the management platform; the at least one downstream pipeline branch including at least one pipeline segment, the pipeline data sequence including pipeline data of the at least one pipeline segment;
obtain, based on an environmental perception device configured in the perception control platform, a pipeline environmental data sequence of the at least one downstream pipeline branch at a preset time period; the pipeline environmental data sequence including pipeline environmental data of the at least one pipeline segment; and
determine the pressure consumption data of the at least one downstream pipeline branch by a pressure consumption model based on the booster task information, the pipeline data sequence, and the pipeline environmental data sequence, the pressure consumption model being a machine learning model.

14. The multi-stage pressure regulating internet of things (IoT) system of claim 13, wherein the inputs of the pressure consumption model further comprise status fluctuation data of the downstream pipeline branch, a cleanliness of the downstream pipeline branch;
the downstream pipeline branching cleanliness is determined in a manner including:
obtaining a cleanup record and a natural gas transportation volume of the at least one downstream pipeline branch from the database of the management platform, and determining, based on the cleanup record and the natural gas transportation volume, a rate of impurity accumulation in the at least one downstream pipeline branch; and
determining the cleanliness of the at least one downstream pipeline branch based on the rate of impurity accumulation and a natural gas transportation volume between a current moment to a previous cleanup moment of the at least one downstream pipeline branch.

15. The multi-stage pressure regulating internet of things (IoT) system of claim 13, wherein the downstream pipeline branches comprise at least one, the management platform being further configured to:
determine, based on the pressure consumption data of the downstream pipeline branch, a theoretical booster parameter of the at least one downstream pipeline branch; and
determine, based on the theoretical booster parameter of the at least one downstream pipeline branch, the characteristic booster parameter of the target booster station.

16. The multi-stage pressure regulating internet of things (IoT) system of claim 12, wherein the management platform is further configured to:
determine, based on the pressure consumption data of the downstream pipeline branch, a theoretical booster parameter of the at least one downstream pipeline branch; and
determine, based on the theoretical booster parameter of the at least one downstream pipeline branch, the characteristic booster parameter of the target booster station.

17. The multi-stage pressure regulating internet of things (IoT) system of claim 6, wherein the at least one downstream pipeline branch includes at least two downstream pipeline branches, and the management platform is further configured to:
determine, based on a historical natural gas transportation volume of each of the at least two downstream pipeline branches, a booster weight of each of the at least two downstream pipeline branches; and
determine the characteristic booster parameter of the target booster station based on the booster weight and the theoretical booster parameter of each of the at least two downstream pipeline branches.

18. The multi-stage pressure regulating internet of things (IoT) system of claim 11, wherein the management platform is further configured to:
determine, based on transportation status data of a correlation pipeline branch of the target booster station, status fluctuation data of the correlation pipeline branch;
determine, based on the status fluctuation data of the correlation pipeline branch, a correlation influence of the correlation pipeline branch; and
determine the associated booster station based on the correlation influence of the correlation pipeline branch.

19. The multi-stage pressure regulating internet of things (IoT) system of claim 18, wherein the linkage booster model is obtained by training which comprising:
obtaining a plurality of training samples with labels to form a training sample set, and executing a plurality of rounds of iterations based on the training sample set, wherein each of the training samples includes a sample booster map, and each of the labels includes sample linkage adjustment parameters corresponding to different nodes in the sample booster map; and at least one of the plurality of rounds of iterations includes:
selecting at least one training sample from the training sample set for input to an initial linkage booster model, obtaining at least one model prediction output corresponding to the at least one training sample;
determining a loss function based on the at least one predicted output corresponding to the at least one training sample and at least one label of the at least one training sample;
iteratively updating model parameters of the initial linkage booster model based on the loss function; and
in response to an end-of-iteration condition being satisfied, ending the iteration to obtain the linkage booster model.

20. A non-transitory computer-readable storage medium, wherein the storage medium stores a computer command, and when the computer command is executed by a processor, the multi-stage pressure regulating method for natural gas transmission in a distributed energy pipeline of claim 1 is implemented.
